(19) United States
(12) Patent Application Publication
(10) Pub. No.: US 2026/0163849 A1
(43) Pub. Date: Jun. 11, 2026

(54) METHOD, APPARATUS, DEVICE, STORAGE MEDIUM AND PROGRAM PRODUCT FOR RESPONSE PROCESSING

(71) Applicant: Beijing Zitiao Network Technology Co., Ltd., Beijing (CN)

(72) Inventors: Longteng PENG, Beijing (CN); Weizhi YAN, Beijing (CN); Wenfeng LIU, Beijing (CN); Haoming ZHENG, Beijing (CN)

(21) Appl. No.: 19/185,332

(22) Filed: Apr. 22, 2025

(30) Foreign Application Priority Data
Dec. 9, 2024 (CN) 202411804771.6

(51) Int. Cl. H04L 51/02; H04L 67/02

(52) U.S. Cl. CPC H04L 51/02; H04L 67/02

(57) ABSTRACT

The disclosure provides a method, an apparatus, a device, a storage medium and a program product for response processing. An example method includes, at a client device, sending, in response to receiving a query request for a digital assistant in a session with the digital assistant, the query request to a server device via a predetermined first communication link; receiving a response message for the query request from the server device via a target communication link of a plurality of communication links, the plurality of communication links including at least a first communication link; and providing the response message as a reply of the digital assistant to the query request.

### CROSS REFERENCE

This application claims priority to Chinese Patent Application No. 202411804771.6, filed on Dec. 9, 2024, and entitled “METHOD, APPARATUS, DEVICE, STORAGE MEDIUM AND PROGRAM PRODUCT FOR RESPONSE PROCESSING”, the entirety of which is incorporated herein by reference.

### FIELD

Example embodiments of the disclosure generally relate to the field of computers, and in particular, to a method, an apparatus, an electronic device, a computer-readable storage medium, and a computer program product for response processing.

### BACKGROUND

With the development of information technologies, various electronic devices may provide various services to people in terms of work and life. For example, an application providing a service may be deployed in a client device. The client device or application may provide a digital assistant type function to a user to assist the user in using the client device or application. The user can accomplish diverse operations through various interactions with the digital assistant.

### SUMMARY

In a first aspect of the disclosure, a method for response processing is provided. The method is implemented at a client device, and the method includes: sending, in response to receiving a query request for a digital assistant in a session with the digital assistant, the query request to a server device via a predetermined first communication link; receiving a response message for the query request from the server device via a target communication link of a plurality of communication links, the plurality of communication links including at least the first communication link; and providing the response message as a reply of the digital assistant to the query request.

In a second aspect of the disclosure, a method for response processing is provided. The method is implemented at a server device, and the method includes receiving a query request for a digital assistant from a client device via a predetermined first communication link; determining a response message corresponding to the query request; and sending the response message to the client device via a target communication link of a plurality of communication links, the plurality of communication links including at least the first communication link.

In a third aspect of the disclosure, an apparatus for response processing is provided. The apparatus is implemented at a client device, and the apparatus includes: a query request sending module configured to send a query request to a server device via a predetermined first communication link in response to receiving the query request for a digital assistant in a session with the digital assistant; a response message receiving module configured to receive a response message for the query request from the server device via a target communication link of a plurality of communication links, the plurality of communication links including at least the first communication link; and a response message providing module configured to provide the response message as a reply of the digital assistant to the query request.

In a fourth aspect of the disclosure, an apparatus for response processing is provided. The apparatus is implemented at a server device, and the apparatus includes: a query request receiving module configured to receive a query request for a digital assistant from a client device via a predetermined first communication link; a response message determining module configured to determine a response message corresponding to the query request; and a response message sending module configured to send the response message to the client device via a target communication link of a plurality of communication links, the plurality of communication links including at least the first communication link.

In a fifth aspect of the disclosure, an electronic device is provided. The electronic device includes at least one processing unit; and at least one memory coupled to the at least one processing unit and storing instructions for being executed by the at least one processing unit, the instructions, when executed by the at least one processing unit, causing the electronic device to perform the method according to the first aspect or the second aspect of the disclosure.

In a sixth aspect of the disclosure, there is provided a computer-readable storage medium having stored thereon a computer program which, when executed by a processor, causes the processor to perform the method according to the first aspect or the second aspect of the disclosure.

In a seventh aspect of the disclosure, a computer program product is provided. The computer program product is tangibly stored in a computer storage medium and includes computer-executable instructions that, when executed by a device, cause the device to perform the method of the first aspect or the second aspect.

It should be understood that the contents described in this summary section are not intended to limit the key features or important features of the embodiments of the disclosure, nor intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, in which:

FIG. 1 illustrates a schematic diagram of an example environment in which embodiments of the disclosure may be implemented;

FIG. 2 illustrates a flowchart of a signaling flow for response processing according to some embodiments of the disclosure;

FIG. 3 illustrates a flowchart of a method for response processing according to some embodiments of the disclosure;

FIG. 4 illustrates a flowchart of a method for response processing according to some other embodiments of the disclosure;

FIG. 5 illustrates an example structural block diagram of an apparatus for response processing according to some embodiments of the disclosure;

FIG. 6 illustrates an example structural block diagram of an apparatus for response processing according to some other embodiments of the disclosure; and

FIG. 7 illustrates a block diagram of an electronic device in which one or more embodiments of the disclosure may be implemented.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as limited to the embodiments set forth herein, but rather, these embodiments are provided for a more thorough and complete understanding of the disclosure. It should be understood that the drawings and embodiments of the disclosure are for illustrative purposes only and are not intended to limit the scope of the disclosure.

In the description of the embodiments of the disclosure, the terms “including” and the like should be understood to inclusively contain, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, “in response to A” performs one step and does not mean that this step is performed immediately after “A”, but may include one or more intermediate steps.

It may be understood that the data involved in the technical solution (including but not limited to the data itself, obtaining, using, storing or deleting of the data) should follow the requirements of the corresponding laws and regulations and related regulations.

It can be understood that, before the technical solutions disclosed in the embodiments of the disclosure are used, the types, usage scope, usage scenario and the like of personal information related to the disclosure should be notified to the user in an appropriate manner according to the relevant laws and regulations, and authorized by the user.

For example, in response to receiving an active request from a user, prompt information is sent to the user to explicitly prompt the user that the requested operation will need to obtain and use personal information of the user, so that the user can autonomously select whether to provide personal information to software or hardware such as the electronic device, application, server, storage medium and the like executing the operation of the technical solution of the disclosure according to the prompt information.

As an optional but non-limiting implementation, in response to receiving an active request of the user, a manner of transmitting prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It may be understood that the foregoing notification and a process of obtaining a user authorization are merely illustrative, and do not constitute a limitation on implementations of the disclosure, and other manners of meeting related laws and regulations may also be applied to implementations of the disclosure.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network,” which terms are used interchangeably herein.

A “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include many hidden layers, increasing the depth of the network. Various layers of the neural network are connected in sequence such that the output of the previous layer is provided as an input to the next layer, where the input layer receives the input of the neural network and the output of the output layer serves as a final output of the neural network. Each layer of the neural network includes one or more nodes (also referred to as processing nodes or neurons), each node processing input from the previous layer.

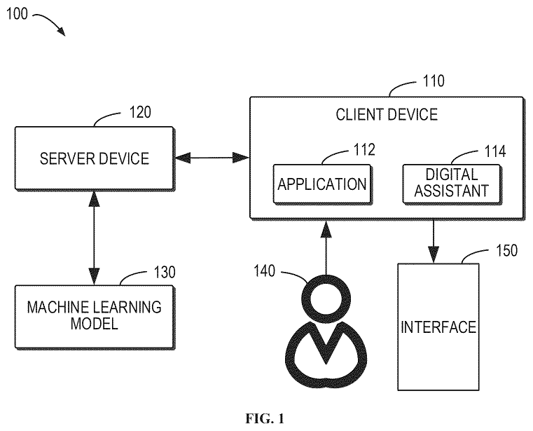

FIG. 1 illustrates a schematic diagram of an example environment 100 in which embodiments of the disclosure may be implemented. In this example environment 100, an application 112 and a digital assistant 114 are installed in a client device 110. The user 140 may interact with the application 112 via the client device 110 and/or an attachment device of the client device 110. In some implementations, the application 112 may be authorized to capture speech via an audio capture device (e.g., a microphone) of the client device 110, to capture images via an image capture device (e.g., a camera) of the client device 110, and/or the like.

In some embodiments, the application 112 and the digital assistant 114 may be downloaded, installed on the client device 110. In some embodiments, the application 112 and the digital assistant 114 may also be accessed in other manners, such as web page access.

In an embodiment of the disclosure, the application 112 may be any suitable application having a response function, which may include, but is not limited to, one or more of the following: a chat application component (also referred to as an instant messaging application component), a browser application component, a planning application component, a document application component, an audio and video conference application component, a mail application component, a task application component, a calendar application component, a target and key result (OKR) application component, and the like. It may be understood that although a single application service component is shown in FIG. 1, in practice, multiple application service components may be installed on the client device 110. In some embodiments, the application 112 may include a multifunctional collaboration platform, for example, an office collaboration platform (also referred to as an office suite), which can provide integration of multiple types of business components, so that people can conveniently perform activities such as office and communication. In the multifunctional collaboration platform, people can start different service components according to needs to complete corresponding information processing, sharing, communication and the like.

In some embodiments, the digital assistant 114 may be provided by a separate application business component, or may be integrated in some application 112 capable of providing a content entity. An application business component for providing a client interface of a digital assistant may correspond to a single function application business component or a multifunctional collaboration platform, such as an office suite or other collaboration platform capable of integrating multiple components. It is to be understood that although a single digital assistant is shown in FIG. 1, a plurality of digital assistants may actually be provided.

In some embodiments, the digital assistant 114 supports the use of plug-ins. Each plug-in may provide one or more functions of the application. Such plug-ins include, but are not limited to, one or more of a search plug-in, a contact plug-in, a message plug-in, a document plug-in, a table plug-in, a mail plug-in, a calendar plug-in, a schedule plug-in, a task plug-in, and the like.

The digital assistant 114 is an intelligent assistant for the user, and has an intelligent dialogue and information processing capability. In an embodiment of the disclosure, the digital assistant 114 is configured to interact with the user 140 to assist the user 140 in using the terminal device or the application. In some embodiments, multiple interaction modes of the user 140 and the digital assistant 114 may be provided, and it may be flexibly switched between multiple interaction modes. In a case that a certain interaction mode is triggered, a corresponding interaction area is presented to facilitate interaction of the user 140 with the digital assistant 114. The interaction manners of the user 140 and the digital assistant 114 in different interaction modes are different, which can flexibly adapt to interaction requirements in different application scenarios.

In the environment 100, in response to application 112 being started, the client device 110 may present an interface 150 of the application 112 and/or the digital assistant 114. The interface 150 may include, for example, an interactive interface of the application 112 and the digital assistant 114. In some embodiments, an interaction window between the user 140 and the digital assistant 114 may be presented in the interface 150. In the interaction window, the user 140 can interact with the digital assistant 114 by inputting a natural language, a picture, an audio file, a video file, a web page file, etc., to instruct the digital assistant to assist in completing various tasks.

The interaction window between the digital assistant 114 and the user 140 may include a session window, such as a session window in an instant messaging module of a particular application or an instant messaging application. In the session window, the interaction between the digital assistant 114 and the user 140 may be presented in a form of a session message. Alternatively or additionally, the interaction window between the digital assistant 114 and the user 140 may further include other types of windows, such as a window in a floating window mode, in which the user 140 may trigger the digital assistant 114 to perform a corresponding operation by inputting an instruction, selecting a shortcut instruction, or the like.

In some embodiments, the digital assistant 114 may support an interaction mode of a session window, which is also referred to as a session mode. In the interaction mode, the session window between the user 140 and the digital assistant 114 is presented, and the user 140 interacts with the digital assistant 114 in the session window through a session message. In the session mode, the digital assistant 114 may perform a task according to the session message in the session window. In the interaction window, the user 140 enters an interaction message, and the digital assistant 114 provides a reply message in response to the user input. By selecting the digital assistant 114, the session window with the digital assistant 114 may be opened. The session window may include interface elements for information interaction, such as an input box, a message list, a message bubble, and the like.

In some embodiments, a communication connection is established between the client device 110 and the server device 120. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the disclosure are not limited in this aspect. In an embodiment of the disclosure, the client device 110 and the server device 120 may implement signaling interaction through a communication connection between the client device 110 and the server device 120, so as to supply services to the application 112 and/or the digital assistant 114.

As shown in FIG. 1, the server device 120 may invoke a machine learning model 130 to support task processing and/or query response functions of the application 112 and/or the digital assistant 114 based on the output of the machine learning model 130. The machine learning model 130 may include one or more machine learning models, which may be collectively referred to herein as the machine learning model 130 for ease of description. The machine learning model 130 may be deployed on the server device 120, or may be deployed on other devices.

The machine learning model 130 may be based on any suitable model structure including, but not limited to, a Transformer model, a convolutional neural network (CNN), a recurrent neural network (RNN), a deep neural network (DNN), and the like. In some embodiments, the machine learning model 130 may be based on a language model (LM). The language model may have question-answering capability by learning from a large corpus. The machine learning model 130 may also be based on other suitable models.

It should be noted that, if the machine learning model 130 includes a plurality of machine learning models, the functions, structures, uses, and the like of the plurality of machine learning models may be the same or different. In some embodiments, in a case that the client device 110 or the application 112 may provide the speech processing service to the user 140, the machine learning model 130 may include at least a plurality of machine learning models related to speech, for example, a machine learning model for performing text to speech TTS (which may be abbreviated as a TTS model), a machine learning model for performing speech recognition ASR (which may be abbreviated as an ASR model), and a machine learning model for performing question and answer (which may be abbreviated as a question and answer model). The input to the ASR model is a speech and the output from the ASR model is a text. The input to the TTS model is a text, and the output from the TTS model is a corresponding speech. The input to the question and answer model is a question text and the output from the question and answer model is a corresponding response text.

The client device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, including accessories and peripherals of these devices, or any combination thereof. In some embodiments, the client device 110 may also support any type of interface for a user (such as a “wearable” circuit, etc.).

The server device 120 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server device 120 may include, for example, a computing system/server, such as a mainframe, an edge computing node, a computing device in a cloud environment, or the like.

It should be understood that the structures and functions of various elements in the environment 100 are described for illustrative purposes only and do not imply any limitation to the scope of the disclosure.

As mentioned above, an application providing services may be deployed in the client device. The client device or application may provide a digital assistant type function to the user to assist the user in using the client device or application. The user may accomplish diverse operations through various interactions with the digital assistant. As an example, in the case of providing a response service, the client device may receive a query request sent by the user for the digital assistant. The client device may send the received query request to the server device via a communication link between the client device and the server device, and receive a response to the query request from the server device. The client device may provide the response to the user.

It can be found that the quality of the response service is affected by the communication link, and the higher the reliability and stability, and the faster data transmission speed of the communication link, the higher the quality of the response service. In the case that the client device is a simpler client device (e.g., a microcontroller unit MCU device), the client device may not always support a communication protocol that requires a higher requirement for the device. It is desired that a relatively simple communication protocol can be used as far as possible to transmit data while ensuring the quality of the response service.

In view of this, according to an embodiment of the disclosure, an improved solution for response processing is provided. According to the solution of the embodiments of the disclosure, at a client device, in response to receiving a query request for a digital assistant in a session with a digital assistant, the query request is sent to the server device via a predetermined first communication link; a response message for the query request is received via a target communication link of the plurality of communication links, the plurality of communication links including at least the first communication link; and the response message is provided as a response of the digital assistant to the query request. At the server device, a request message is received from the client device via the predetermined first communication link, the request message is generated based on a query request for the digital assistant, the query request corresponds to a plurality of request messages, and each request message includes at least a part of the query request; a response message corresponding to the query request is determined in response to receiving the plurality of request messages; and the response message is sent to the client device via the target communication link of the plurality of communication links.

In this way, the client device and the server device may select an appropriate communication link from the plurality of communication links to transmit the response message, which may improve the quality and efficiency of data transmission in the response process, thereby improving the quality and efficiency of the response processing.

Some example embodiments of the disclosure will be described below with continued reference to the accompanying drawings.

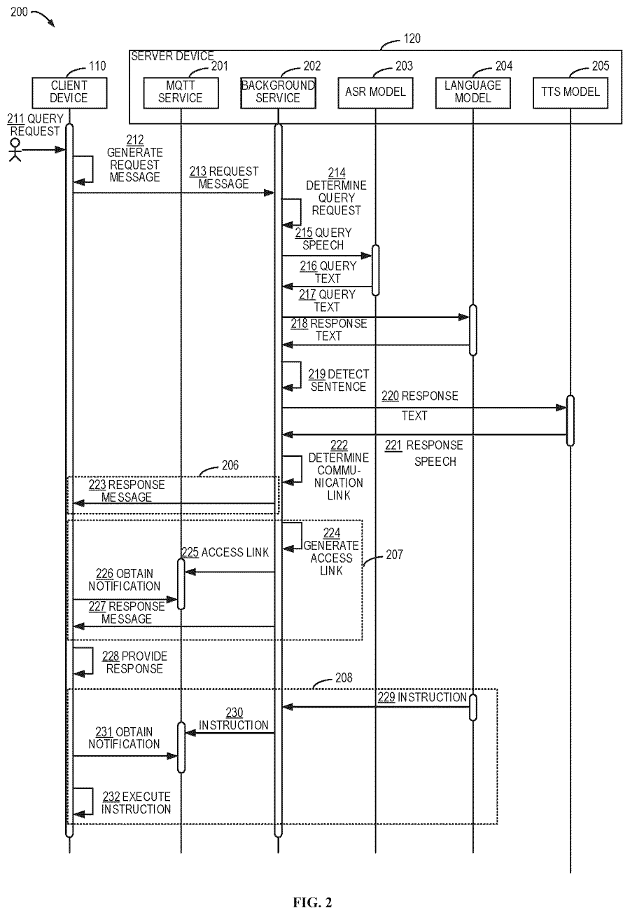

FIG. 2 illustrates a flowchart of a signaling flow 200 for response processing according to some embodiments of the disclosure. For ease of discussion, the signaling flow 200 is described with reference to FIG. 1. As shown in FIG. 2, the signaling flow 200 relates to the client device 110 and the server device 120. In some embodiments, the server device 120 may include a Message Queuing Telemetry Transport (MQTT) service 201, a background service 202, an Automatic Speech Recognition (ASR) model 203, a language model 204, and a Text to Speech (TTS) model 205. The MQTT service 201 may provide communication support based on a MQTT protocol communication. The background service 202 may provide background support for services of the digital assistant. The ASR model 203, the language model 204, and the TTS model 205 may be invoked for determining a model for a query request to the digital assistant or for processing a response therefrom.

The ASR model 203 may be configured to perform speech recognition on a received speech to determine a text corresponding to the speech, and the TTS model 205 may be configured to perform text-to-speech on a received text to determine a speech corresponding to the text. The language model 204 is configured to generate, based on a received question, a response corresponding to the question. The ASR model 203, the language model 204, and the TTS model 205 may each be based on any suitable model structure including, but not limited to, a Transformer model, a convolutional neural network (CNN), a recurrent neural network (RNN), a deep neural network (DNN), and the like.

The client device 110 may receive (211), in a session of a user (e.g., the user 140) and a digital assistant (e.g., the digital assistant 114), a query request sent by the user for the digital assistant. The client device 110 may receive the query request in any suitable manner. For example, the client device 110 may receive a speech type query request input by the user via a microphone, receive a text type query request input by the user via an input box, receive a gesture type query request via a camera, and/or the like. The disclosure does not limit the manner in which the query request is received.

The client device 110 may send the query request to the server device 120 via a predetermined first communication link in response to receiving the query request. The first communication link may include, for example, a communication link based on a user datagram (UDP) protocol (which may be referred to as a UDP link). The UDP protocol is a simple transport layer protocol that can provide a connectionless communication service. The UDP protocol is a transmission protocol with a relatively fast transmission speed, but an unreliable transport protocol, which allows the encapsulated IP data packet to be transmitted without ensuring the order, integrity or reliability of the data packet.

In some embodiments, the client device 110 may send the query request directly to the server device 120 via the UDP link. In some other embodiments, the client device 110 may generate (212) at least one request message based on the query request according to a predetermined data structure corresponding to the UDP protocol. It may be understood that each request message includes at least a portion of the query request. It may also be understood that portions of the query request included in different request messages do not overlap with each other. For example, if the client device 110 generates 4 request messages based on the query request, each request message may include a quarter (¼) of the content of the query request.

The client device 110, for example, may determine, according to a predetermined length, how much content of the query request is included in each request message. As an example, if the query request is a speech type query request, the predetermined length may be a predetermined duration, and each request message includes audio of the query request having a predetermined duration. For example, in the case that the query request is an audio of 30 seconds and the predetermined length is 5 seconds, each request message may include 5 seconds of audio in the query request. If the query request is a text type query request, the predetermined length may be a predetermined text number, and each request message includes a text of the query request having a predetermined text number. For example, in the case that the query request is a text of 50 words and the predetermined text number is 10, each request message may include 10 words in the query request.

Each request message may further include an identifier of the session. The identifier of the session may include any suitable identifier such as a text, a symbol, an image, an icon, or the like, which may also be referred to as a session ID, for example. Each request message may further include a content type of the query request, and the content type includes at least a speech type and a text type. As an example, the content type of the query request may further include any suitable type such as an image type and a video type. Each request message may also include a ranking of the request message in the at least one request message. Each request message may further include whether the request message is the last request message in the at least one request message. It may be understood that each request message may further include one or more of the identifier of the session, the content type of the query request, the ranking, and whether the request message is the last request message, which is not limited in the disclosure. Referring to Table 1, Table 1 shows an example of a request message generated according to a predetermined data structure:

```
TABLE 1
{
  “chat_id”:1, // ID of the session
  “msg_type”:1, // content type, for example: 1 is speech type, 2 is text
  type
  “index”: 1, // ranking of message
  “last_msg”: false, // whether the last message it is
  “payload”: “xxxx” / / actual content, for example, speech content
  corresponding to the query request
}
```

Thus, the client device 110 may send (213) the request message to the server device 120 via the UDP link. Specifically, the client device 110 may send the request message to the background service 202 in the server device 120 via the UDP link. In some embodiments, if the query request corresponds to a plurality of request messages, the client device 110 may send only one request message to the server device 120 each time, or may send a group of request messages to the server device 120 each time, where each group of request messages may include at least one request message.

The server device 120 (specifically, for example, the background service 202) may receive the query request directly from the client device 110 via the UDP link. In some embodiments, the background service 202 may also receive a request message from the client device 110 via the UDP link. The request message is generated based on the query request for the digital assistant. The query request may correspond to at least one request message. Each request message includes at least a portion of the query request.

In the case that the query request corresponds to the plurality of request messages, the background service 202 may, for example, further determine that a received target request message is the last request message in the plurality of request messages in response to the target request message including a content indicating that it is the last request message in the plurality of request messages, and the background service 202 may further determine, based on a target ranking of the target request message in the plurality of request messages, that the plurality of request messages have been received in response to determining that all other request messages located before the target ranking have been received. For example, the background service 202 may parse the plurality of request messages according to a predetermined data structure corresponding to the UDP protocol to determine (214) the query request.

The background service 202 may further determine a response message corresponding to the query request. The background service 202 may determine the content type of the query request. For example, the background service 202 may determine the content type of the query request while parsing the plurality of request messages according to the predetermined data structure corresponding to the UDP protocol to determine the query request. If the content type of the query request is a speech type, the query request may be referred to as a query speech.

The background service 202 may provide (215) the query speech to the ASR model 203. The ASR model 203 may perform a speech recognition function on the query speech to determine a query text corresponding to the query speech. The background service 202 may obtain (216) the query text from the ASR model 203. The background service 202 may provide (217) the query text to the language model 204. The language model 204 may determine a response text corresponding to the query text based on the query text. The background service 202 may obtain (218) the response text from the language model 204. The background service 202 may provide (220) the reply text to the TTS model 205.

In some embodiments, the language model 204 may generate the response text based on the query text, and provide the entire response text to the background service 202 when the response text is completely generated (that is, the background service 202 may obtain the entire response texts at once). In some other embodiments, the language model 204 may further generate a response text in a streaming mode based on the query text. In this case, the background service 202 may obtain the reply text from the language model 204 in a streaming mode. For example, the background service 202 may obtain response text from the language model 204 one word by one word. The background service 202 may detect (219) whether the received text can form a sentence, and in response to determining that the received text can form a sentence, provide the received sentence to the TTS model 205.

The background service 202 may detect whether the received text can form a sentence in any suitable manner. As an example, the background service 202 may determine, in response to detecting a break symbol such as a period “.”, an exclamation point “!”, an ellipse “ . . . ”, a question mark “?” or the like, that the received text can form a sentence. For example, the background service 202 may, in response to having provided the received sentence to the TTS model 205 and the response text being not yet received, continue to receive a new text from the language model 204 and continuously detect whether the newly received text can form a sentence.

The TTS model 205 may perform a text-to-speech function on the received response text (which may be the entire response text or one sentence of the response text) to determine a response speech corresponding to the response text. The background service 202 may obtain (221) the response speech from the TTS model 205.

For another example, if the content type of the query request is a text type, the query request may be directly referred to as a query text. The background service 202 may directly provide the query text to the language model 204, and obtain the response text for the query text from the language model 204. In this case, the background service 202 may not need to determine the response speech by means of the TTS model 205, or may still determine the response speech by means of the TTS model 205, which may be specifically determined based on the user's setting for the response. The response speech or the response text may be collectively referred to as a response message determined by the background service by using a machine learning model (specifically, a language model).

In some embodiments, the background service 202 may determine (222) a target communication link for message transmission from a plurality of communication links including at least a first communication link, such as a UDP link. In some embodiments, the plurality of communication links may also include a message queuing telemetry transport MQTT link and/or a communication link corresponding to a hypertext transfer HTTP protocol (which may be referred to as an HTTP link). Depending on the determined type of the target communication link (e.g., the UDP link, the HTTP link, or the MQTT link), sending of the response message may include operations corresponding to schemes 206, 207, or 208.

The MQTT is a lightweight, publish/subscribe pattern based message transport protocol, typically used for communication between an Internet of Things (IoT) device and a mobile device. A design objective of the MQTT protocol is providing reliable message transport in a low bandwidth, high latency, or unreliable network environment. The HTTP protocol is an application layer protocol for transferring hypertext from a network, which defines criteria for requests and responses between a client and a server. The HTTP is stateless, meaning that each request is independent, and the server does not save any information about the previous request. A communication latency of the UDP link is lower than a communication latency of each of the MQTT link and the HTTP link, and a communication reliability of the UDP link is lower than a communication reliability of each of the MQTT link and the HTTP link.

The background service 202 may, for example, determine a networking capability of the client device 110, and determine a target communication link for the message transmission from the plurality of communication links based on the networking capability of the client device 110. In some embodiments, if the received query request corresponds to a plurality of request messages, the background service 202 may determine the networking capability of the client device 110 based on the ranking indicated by the plurality of request messages and the receiving sequence of the plurality of request messages in response to receiving the plurality of request messages. As an example, the background service 202 may determine a matching condition between the ranking indicated by the plurality of request messages and a receiving sequence of the plurality of request messages. It may be understood that, if the ranking indicated by a request message is the same as the receiving sequence of the request message (for example, the sixth request message is the sixth received), it is determined that the ranking indicated by the request message matches with the receiving sequence of the request message.

The background service 202 may compare the number of request messages in which the matching condition indicates that the ranking is not matched with the receiving sequence to a predetermined number, and determine the networking capability of the client device 110 based on the comparison result. For example, the background service 202 may determine that the networking capability of the client device 110 is strong in response to the matching condition indicating that the number of request messages in which the ranking is not matched with the receiving sequence does not reach the predetermined number, and determine that the networking capability of the client device 110 is poor in response to the matching condition indicating that the number of request messages in which the ranking is not matched with the receiving sequence reaches the predetermined number.

For example, if the plurality of request messages include 10 request messages, and the predetermined number is 5, the background service 202 may determine that the networking capability of the client device 110 is poor in response to that there are 6 request messages, in which the ranking is not matched with the receiving sequence, in the 10 request messages, and may determine that the networking capability of the client device 110 is stronger in response to that there are 3 request messages, in which the ranking is not matched with the receiving sequence, in the 10 request messages.

The background service 202 may, for example, determine a capability level corresponding to the networking capability of the client device 110. The background service 202 may, for example, predetermine a correspondence between the networking capability of the client device 110 and the capability level. For example, the background service 202 may determine that the networking capability is at a capability level A when it is in an interval of [a1, b1), when the networking capability is at a capability level B when it is in an interval of [a2, b2)], and the networking capability is at a capability level C when it is in an interval of [a3, b3), and so on. It can be understood that there is no same value in different intervals. For example, the same value may not exist in the interval [a1, b1) and the interval [a2, b2).

The background service 202 may determine that the networking capability is poor in response to the networking capability of the client device 110 being lower than a certain capability level (for example, the capability level A), and it is necessary to use a communication link with a higher communication reliability to ensure the quality of data transmission. The background service 202 may determine a second communication link as the target communication link, and a communication reliability of the second communication link is higher than the communication reliability of the first communication link. The background service 202 may also determine the first communication link as the target communication link in response to the networking capability of the client device 110 being above a certain capability level (e.g., the capability level B). The two capability levels (that is, the capability level A and the capability level B) may be the same capability level or different capability levels.

In the case that the two capability levels are different capability levels (i.e., the capability level A≠the capability level B), the capability level A may be lower than the capability level B. That is, the background service 202 may determine the second communication link as the target communication link in response to the networking capability of the client device 110 being lower than the lower capability level A, and may determine the first communication link as the target communication link in response to the networking capability of the client device 110 being higher than the higher capability level B.

The background service 202 may also, for example, determine a target communication link for message transmission from the plurality of communication links based on a link indication sent by the client device 110 to the server device 120 (e.g., the background service 202). The link indication may be provided to the background service 202 via the MQTT link. That is, the client device 110 may send the link indication to the background service 202 via the MQTT link.

The client device 110 may provide a link indication to the background service 202 of the server device 120 in response to receiving a selection of a target communication link from the plurality of communication links (e.g., the client device 110 may determine that the selection of the target communication link is received in response to receiving a selection operation for the target communication link by the user), the link indication including an indication for the selected target communication link. In some embodiments, the client device 110 may also determine, in response to determining that the link indication is sent to the server device 120, the communication link indicated by the link indication as the target communication link for message receiving.

The client device 110 may also detect its own networking capability, and in response to the networking capability of the client device 110 being lower than a certain capability level (for example, the capability level C), determine that the networking capability is poor, and it is necessary to use a communication link with a higher communication reliability to ensure the quality of data transmission. The client device 110 may determine the second communication link as the target communication link, and provide a link indication indicating the second communication link to the background service 202. The communication reliability of the second communication link is higher than the communication reliability of the first communication link. The client device 110 may also determine, in response to the networking capability of the client device 110 being above a certain capability level (e.g., a capability level D), the first communication link as the target communication link, and provide a link indication indicating the first communication link to the background service 202. The two capability levels (that is, the capability level C and the capability level D) may be the same capability level or different capability levels.

Similarly, in the case that the two capability levels are different capability levels (i.e., the capability level C≠the capability level D), the capability level C may be lower than the capability level D. That is, the client device 110 may provide the link indication indicating the second communication link to the background service 202 in response to the networking capability of the client device 110 being lower than the lower capability level C, and may provide the link indication indicating the first communication link to the background service 202 in response to the networking capability of the client device 110 being higher than the higher capability level D.

Thus, the background service 202 may determine a target communication link for the message transmission from the plurality of communication links based on the received link indication. For example, the background service 202 may determine that the target communication link is a UDP link in response to the link indication including an indication for the UDP link, may determine that the target communication link is an HTTP link in response to the link indication including an indication for the HTTP link, and/or the like.

It should be noted that, in some embodiments, the server device 120 determines, in response to receiving the link indication during a predetermined time period after receiving the query request/request message, the target communication link based on the received link indication. Accordingly, the client device 110 may also determine, in response to determining that the link indication is sent to the server device 120 during a predetermined time period after sending the query request/request message, the communication link indicated by the link indication as the target communication link for message receiving. The predetermined time period may be determined based on a time difference between the server device 120 receiving the query request and sending a response message for the query request. For example, if the server device 120 receives the query request at a time A and sends the response message at a time B, the predetermined time period may be any suitable time period less than that from the time point A to the time point B. The predetermined time period may also be determined based on a predetermined setting.

As an example, the predetermined time period may be 5 milliseconds, and if the client device 110 sends the link indication to the server device 120 within 5 milliseconds after sending the query request, the communication link indicated by the link indication may be determined as the target communication link for message receiving. The server device 120 may also determine, in response to receiving the link indication within 5 milliseconds after receiving the query request, the target communication link based on the link indication. The server device 120 may also, in response to receiving the link indication at 7th millisecond after receiving the query request, ignore the link indication, or determine the communication link for sending the next response message as the communication link indicated by the link indication. It may be understood that, if the link indication is sent before sending the query request or sent with the query request, the communication link used to send the response message for the query request may be determined based on the link indication. Thus, the client device 110/the server device 120 may determine the communication link based on the link indication that was successfully transmitted/received within a predetermined time period.

The background service 202 may also determine the target communication link for message transmission from the plurality of communication links based on the message type of the response message, for example. The message type may include, for example, an instruction type and a non-instruction type. The instruction type response message may include one or more instructions to be executed locally by the client device 110, such as a turn-on or turn-off instruction of a Bluetooth device, a volume adjustment instruction, or the like. After these instructions are sent to the client device 110, the client device 110 may receive and execute the one or more instructions. The non-instruction type response message may include contents to be presented to the user, such as a text or a speech. The non-instruction type response message may be presented in an interactive interface and/or played to the user (e.g., in the case of including a speech).

For example, the background service 202 may determine the MQTT link as the target communication link in response to the message type of the response message being the instruction type. For example, if the response message is an instruction to be executed by the client device 110, the background service 202 may determine an instruction to be sent to the client device 110 via the MQTT link. The background service 202 may also, for example, determine the target communication link from the UDP link and the HTTP link (e.g., determine the target communication link from the UDP link and the HTTP link based on the networking capability of the client device 110) in response to the message type of the response message being the non-instruction type. For example, if the response message is a general response text or speech, the background service 202 may determine a response text or speech to be sent to the client device 110 via the UDP link or HTTP link.

The background service 202 may send the response message to the client device 110 via the determined target communication link. In some embodiments, if it is determined that the response message is of the non-instruction type and the target communication link is determined as the first communication link (for example, the UDP link), the background service 202 may collectively refer to the response speech or the response text determined by using the machine learning model as a response determined by the background service using the machine learning model (specifically, the language model), and generate at least one response message based on the response according to a predetermined data structure corresponding to the UDP protocol. It will be appreciated that each response message in this case includes at least a portion of the response. It may also be understood that portions of the response included in different response messages do not overlap with each other. As an example, the background service 202 may generate 5 response messages based on the response, that is, each response message includes one fifth (⅕) of the response.

The background service 202 may determine, for example, how much content of the response each response message includes according to a predetermined length. As an example, if the response is a response speech, the predetermined length may be a predetermined duration, and each response message includes an audio having a predetermined duration in the response speech. If the response is a response text, the predetermined length may be a predetermined text number, and each response message includes a text having a predetermined text number in the response.

Each response message may also include an identifier of the session that received the query request. The identifier of the session may include any suitable identifier such as a text, a symbol, an image, an icon, or the like, which may also be referred to as a session ID, for example. Each response message may further include a content type of the response, and the content type includes at least a speech type and/or a text type. As an example, the content type of the response may further include any suitable type such as an image type and a video type. Each response message may also include a ranking of the response messages in the at least one response message. Each response message may further include whether the response message is the last request message in the at least one request message. Each response message may also include a length of at least a portion of the response included in the response message. The length of at least a portion of the response included in the response message is the predetermined length as mentioned above. For example, if each response message includes an audio having a predetermined duration in the response speech, the length of at least a portion of the response included in the response message is the predetermined duration. It may be understood that each response message may further include one or more of the identifier of the session, the content type of the response, the ranking, whether the response message is the last request message, and the length, which is not limited in the disclosure. Referring to Table 2, Table 2 shows an example of a response message generated according to a predetermined data structure:

```
TABLE 2
{
  “chat_id”:1, // ID of the session
  “msg_type”:1, // content type, for example: 1 is speech type, 2 is text
  type
  “index”:1 , // which paragraph of reply content
  “last_msg”: false, // whether the last message it is
  “payload”:“xxxx” // actual content, for example, speech content
  corresponding to the response speech
  “audio_ms”: 2000 // length of current response speech, such as speech
  content having a length of 2s here
}
```

If it is determined that the target communication link for message transmission includes a UDP link, in the scheme 206, the background service 202 may send (223) a response message to the server device 120 via the UDP link.

In some embodiments, if it is determined that the response message is of a non-instruction type and the target communication link is determined as an HTTP link (i.e., it is determined that a response message is to be sent via the HTTP link, the response message in this case may be a response text or a response voice directly), the background service 202 may provide a first message notification including an access link of the response message to the client device 110 via a MQTT link, and send the response message to the client device 110 based on the access link via the HTTP link. This corresponds to the scheme 207 shown in FIG. 2.

Specifically, the background service 202 may save the response message in a predetermined format (that is, the response text or the response speech generated by using the machine learning model is saved in the predetermined format), and this predetermined format is a format that may be supported by the client device 110. As an example, if the response message is a response speech, the predetermined format may be a M P 3 format, and if the response message is a response text, the predetermined format may be a TXT format, or the like. The predetermined format may be preset. Thus, the background service 202 may generate (224) an access link for the saved response message, and provide (225) the access link to the MQTT service 201.

The MQTT service 201 in the server device 120 may determine, in response to obtaining the access link, a first message notification including an access link based on the access link. The client device 110 may receive (226), via the MQTT link, a first message notification provided by the server device 120, the first message notification including an access link for the response message, and the response message being a non-instruction type. The client device 110, for example, may determine, in response to receiving the first message notification, that a response message is to be obtained via the HTTP link (i.e., determine that the target communication link to be used for data receiving is an HTTP link). If the first message notification is received and it is determined that the first message notification includes the access link, the client device 110 may receive (227) a response message from the server device 120 based on the access link via the HTTP link. For example, the client device 110 may send an information obtaining request to the server device 120 in response to receiving the first message notification, and further receive a response message from the server device 120 via the HTTP link. For another example, the client device 110 may further play the response message via a speaker.

In addition to the client device 110 actively obtaining the response message based on the access link, in some embodiments, the client device 110 may first provide the access link to the user after receiving the first message notification. For example, the client device 110 may provide the access link in a user interface. For another example, the client device 110 may also play the access link via a speaker. The client device 110 may receive, in response to receiving a triggering to the access link by the user, a response message from the server device 120 via the HTTP link based on the access link.

The client device 110 may provide (228) the response message to the user. The provided response message may, for example, serve as a reply of the digital assistant for the query request in the session. As an example, in a session between a user and a digital assistant, the query request may be presented in a form of a session message from the user, and the response message may be presented in a form of a session message from the digital assistant.

In some embodiments, if the response message is directly a response text or a response speech, the client device 110 may directly provide the response message to the user. For example, the response text is directly presented via the user interface, or the response speech is played via the speaker. In some embodiments, if the response message received by the client device 110 is a response message received via the UDP link (i.e., the response message is a response message generated based on the response text/response speech, and each response message includes at least a part of the response text/response speech), the client device 110 may parse, in response to receiving the response message, the response message according to the predetermined data structure corresponding to the UDP protocol to determine the response text/response speech to be provided.

The response message described above is a non-instruction type data transmission mode, and the following further describes the response message as the instruction type data transmission mode. As mentioned above, the background service 202 may determine the MQTT link as the target communication link in response to the message type of the response message being the instruction type. The transmission of the response message in this case would correspond to the scheme 208 of FIG. 2. The background service 202 may obtain (229) the instruction type response message from the language model 204. The instruction type response message may be considered as an instruction. In some embodiments, the background service 202 may also obtain a non-instruction type response message (for example, a response text) from the language model 204, and determine whether the response message triggers an instruction. The background service 202 may, in response that the response message may trigger the instruction, determine a corresponding instruction based on the response message. The instruction triggered by the instruction type response message and the instruction triggered by the non-instruction type response message may be collectively referred to as an instruction associated with the response message.

Thus, the background service 202 may provide (230) the instruction associated with the response message to the MQTT service 201. The MQTT service 201 in the server device 120 may determine, in response to obtaining the instruction, a second message notification including the instruction based on the instruction. The client device 110 may receive (231), via the MQTT link, a second message notification provided by the server device 120. The client device 110 may obtain the instruction based on the second message notification, and execute (232) the instruction.

In summary, the client device and the server device may transmit a query request via a predetermined first communication link with a higher transmission speed, and transmit a response message for the query request via a second communication link determined from a plurality of communication links. The first communication link and the second communication link may be the same communication link or different communication links. That is, the query request and the response message may be transmitted via different communication links. Therefore, the client device and the server device may select an appropriate communication link from the plurality of communication links to transmit the response message, which may improve the quality and efficiency of data transmission in the response process, thereby improving the quality and efficiency of the response processing.

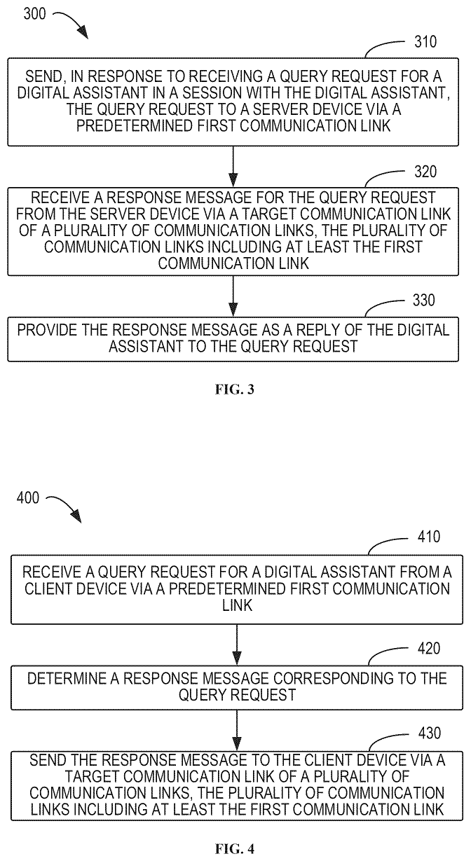

FIG. 3 illustrates a flowchart of a method 300 for response processing according to some embodiments of the disclosure. The method 300 may be implemented at a client device 110.

At block 310, the client device 110 sends, in response to receiving a query request for a digital assistant in a session with the digital assistant, the query request to a server device via a predetermined first communication link.

At block 320, the client device 110 receives a response message for the query request from the server device via a target communication link of a plurality of communication links, the plurality of communication links including at least the first communication link.

At block 330, the client device 110 provides the response message as a reply of the digital assistant to the query request.

In some embodiments, the target communication link is determined from the plurality of communication links based on at least one of: a networking capability of the client device, a link indication sent by the client device to the server device, and a message notification from the server device.

In some embodiments, the method 300 further includes: providing, in response to receiving a selection of a target communication link from the plurality of communication links, the link indication to the server device, the link indication including an indication for the selected target communication link; or sending, in response to determining that a networking capability of the client device is higher than a first capability level, the link indication indicating the first communication link to the server device; or providing, in response to determining that the networking capability of the client device is lower than a second capability level, a link indication indicating a second communication link to the server device, a communication reliability of the second communication link being higher than a communication reliability of the first communication link.

In some embodiments, the link indication is provided to the server device via a message queuing telemetry transport MQTT link. In some embodiments, the target communication link includes a communication link indicated by the link indication.

In some embodiments, the target communication link includes a communication link corresponding to a hypertext transfer HTTP protocol, which is different from the first communication link, and receiving the response message from the server device via the target communication link includes: receiving a first message notification provided by the server device via the MQTT link, the first message notification including an access link for the response message, and the response message being of a non-instruction type; and receiving, in response to receiving the first message notification, the response message from the server device based on the access link via the communication link corresponding to the HTTP protocol.

In some embodiments, the target communication link includes an MQTT link which is different from the first communication link, and receiving the response message from the server device via the target communication link includes: receiving a second message notification provided by the server device via the MQTT link, the second message notification including a response message of an instruction type.

In some embodiments, the first communication link includes a communication link based on a user datagram UDP protocol, and sending the query request to the server device via the predetermined first communication link includes: generating at least one request message based on the query request according to a predetermined data structure corresponding to the UDP protocol, each of the at least one request message including at least a portion of the query request and further including at least one of: an identifier of the session, a content type of the query request, the content type including at least a speech type and/or a text type, a ranking of the request message in the at least one request message, and whether the request message is a last request message in the at least one request message; and sending the at least one request message to the server device via the first communication link.

FIG. 4 illustrates a flowchart of a method 400 for response processing according to some other embodiments of the disclosure. The method 400 may be implemented at a server device 120.

At block 410, the server device 120 receives a query request for a digital assistant from a client device via a predetermined first communication link.

At block 420, the server device 120 determines a response message corresponding to the query request.

At block 430, the server device 120 sends the response message to the client device via a target communication link of a plurality of communication links, the plurality of communication links including at least the first communication link.

In some embodiments, the method 400 further includes determining the target communication link from the plurality of communication links based on at least one of: a networking capability of the client device, a link indication sent by the client device to the server device, and a message type of the response message.

In some embodiments, determining the target communication link for message transmission from the plurality of communication links based on the networking capability of the client device includes: determining the networking capability of the client device; determining, in response to the networking capability of the client device being lower than a third capability level, the second communication link as the target communication link, a communication reliability of the second communication link being higher than a communication reliability of the first communication link; and determining, in response to the networking capability of the client device being higher than a fourth capability level, the first communication link as the target communication link.

In some embodiments, receiving the query request includes receiving a plurality of request messages corresponding to the query request, and each of the plurality of request messages includes at least a portion of the query request; and determining the networking capability of the client device includes: determining, in response to receiving the plurality of request messages corresponding to the query request, the networking capability of the client device based on a ranking indicated by the plurality of request messages and a receiving sequence of the plurality of request messages.

In some embodiments, determining the target communication link for the message transmission from the plurality of communication links based on the link indication sent by the client device to the server device includes: determining, in response to receiving the link indication, a communication link indicated by the link indication as the target communication link.

In some embodiments, the plurality of communication links further includes a message queuing telemetry transport MQTT link, and determining the target communication link for the message transmission from the plurality of communication links based on the message type of the response message includes: determining, in response to the message type of the response message being an instruction type, the MQTT link as the target communication link.

In some embodiments, the target communication link includes an MQTT link which is different from the first communication link, and the method 400 further includes: providing a first message notification to the client device via the MQTT link in response to determining that the response message is of a non-instruction type and determining that the response message is sent via the communication link corresponding to the HTTP protocol, the first message notification including an access link of the response message; and sending the response message to the client device based on the access link via the communication link corresponding to the HTTP protocol.

In some embodiments, the first communication link includes a communication link based on a user datagram (UD P) protocol, and determining the response message corresponding to the query request includes: parsing the plurality of request messages according to a predetermined data structure corresponding to the UDP protocol to determine the query request; and determining, by using a trained language model, the response message corresponding to the query request based on the query request.

In some embodiments, if the target communication link is the first communication link, determining the response message corresponding to the query request based on the query request includes: determining, by using the trained language model, a response corresponding to the query request based on the query request; and generating at least one response message based on the response according to the predetermined data structure corresponding to the UDP protocol, each of the at least one response message including at least a portion of the response and further including at least one of: an identifier of a session for receiving the query request, a content type of the response, a content type including at least a speech type and a text type, a ranking of the response message in the at least one response message, whether the response message is a last response message in the at least one response message, and a length of at least a portion of the response included in the response message.

Embodiments of the disclosure also provide a corresponding apparatus for implementing the above method or process. FIG. 5 illustrates an example structural block diagram of an apparatus 500 for response processing according to some embodiments of the disclosure. The apparatus 500 may be implemented or included in the client device 110. Various modules/components in the apparatus 500 may be implemented by a hardware, software, firmware, or any combination thereof.

As shown in FIG. 5, the apparatus 500 includes a query request sending module 510, configured to send, in response to receiving a query request for a digital assistant in a session with the digital assistant, the query request to a server device via a predetermined first communication link. The apparatus 500 further includes a response message receiving module 520 configured to receive a response message for the query request from the server device via a target communication link of a plurality of communication links, the plurality of communication links including at least the first communication link. The apparatus 500 further includes a response message providing module 530 configured to provide the response message as a reply of the digital assistant to the query request.

In some embodiments, the target communication link is determined from the plurality of communication links based on at least one of: a networking capability of the client device, a link indication sent by the client device to the server device, and a message notification from the server device.

In some embodiments, the apparatus 500 further includes: a first link indication sending module, configured to provide, in response to receiving a selection of a target communication link from the plurality of communication links, a link indication to the server device, the link indication including an indication for the selected target communication link; or a second link indication sending module, configured to send, in response to determining that a networking capability of the client device is higher than a first capability level, a link indication indicating the first communication link to the server device; or a third link indication sending module, configured to provide, in response to determining that the networking capability of the client device is lower than a second capability level, a link indication indicating a second communication link to the server device, and a communication reliability of the second communication link is higher than a communication reliability of the first communication link.

In some embodiments, the link indication is provided to the server device via a message queuing telemetry transport MQTT link. In some embodiments, the target communication link includes a communication link indicated by the link indication.

In some embodiments, the target communication link includes a communication link corresponding to a hypertext transfer HTTP protocol which is different from the first communication link, and the response message receiving module 520 is further configured to: receive, via the MQTT link, a first message notification provided by the server device, the first message notification including an access link for the response message, and the response message being a non-instruction type; and receive, in response to receiving the first message notification, a response message from the server device based on the access link via the communication link corresponding to the HTTP protocol.

In some embodiments, the target communication link includes an MQTT link which is different from the first communication link, and the response message receiving module 520 is further configured to receive, via the MQTT link, a second message notification provided by the server device, the second message notification including an instruction type response message.

In some embodiments, the first communication link includes a communication link based on a user datagram (UDP) protocol, and the query request sending module 510 is further configured to: generate at least one request message based on the query request according to a predetermined data structure corresponding to the UDP protocol, each of the at least one request message including at least a portion of the query request and further including at least one of: an identifier of the session, a content type of the query request, a content type including at least a speech type and a text type, a ranking of the request message in the at least one request message, and whether the request message is a last request message in the at least one request message; and send the at least one request message to the server device via the first communication link.

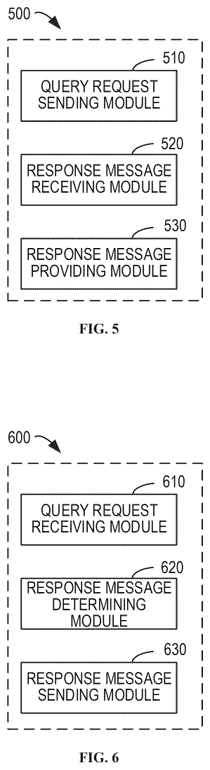

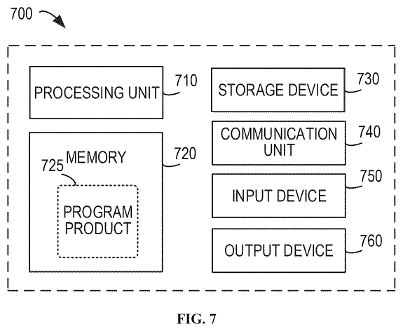

FIG. 6 illustrates an example structural block diagram of an apparatus 600 for response processing according to some other embodiments of the disclosure. The apparatus 600 may be implemented or included in a server device 120. Various modules/components in the apparatus 600 may be implemented by a hardware, software, firmware, or any combination thereof.

As shown in FIG. 6, the apparatus 600 includes a query request receiving module 610 configured to receive a query request for a digital assistant from a client device via a predetermined first communication link. The apparatus 600 further includes a response message determining module 620 configured to determine a response message corresponding to the query request. The apparatus 600 further includes a response message sending module 630 configured to send the response message to the client device via a target communication link of the plurality of communication links, the plurality of communication links including at least the first communication link.

In some embodiments, the target communication link is determined from the plurality of communication links based on at least one of: a networking capability of the client device, a link indication sent by the client device to the server device, and a message type of the response message.

In some embodiments, determining the target communication link for message transmission from the plurality of communication links based on the networking capability of the client device includes: determining the networking capability of the client device; determining the second communication link as the target communication link in response to the networking capability of the client device being lower than a third capability level, a communication reliability of the second communication link being higher than a communication reliability of the first communication link; and determining the first communication link as the target communication link in response to the networking capability of the client device being higher than a fourth capability level.

In some embodiments, receiving the query request includes receiving a plurality of request messages corresponding to the query request, and each of the plurality of request messages includes at least a portion of the query request; and determining the networking capability of the client device includes: determining, in response to receiving the plurality of request messages corresponding to the query request, the networking capability of the client device based on a ranking indicated by the plurality of request messages and a receiving sequence of the plurality of request messages.

In some embodiments, determining the target communication link for the message transmission from the plurality of communication links based on the link indication sent by the client device to the server device includes: determining, in response to receiving the link indication, the communication link indicated by the link indication as the target communication link.

In some embodiments, the plurality of communication links further includes a message queuing telemetry transport (MQTT) link, and determining the target communication link for the message transmission from the plurality of communication links based on the message type of the response message includes: determining, in response to the message type of the response message being an instruction type, the MQTT link as the target communication link.

In some embodiments, the target communication link includes an MQTT link which is different from the first communication link, and the apparatus 600 further includes: a message notification providing module configured to provide, in response to determining that the response message is of a non-instruction type and to determining that the response message is sent via the communication link corresponding to the HTTP protocol, a first message notification to the client device via the MQTT link, the first message notification including an access link of the response message; and a message sending module configured to send the response message to the client device based on the access link via the communication link corresponding to the HTTP protocol.

In some embodiments, the first communication link includes a communication link based on a user datagram (UDP) protocol, and the response message determining module 620 is further configured to parse the plurality of request messages according to a predetermined data structure corresponding to the UDP protocol to determine the query request; and determine, by using a trained language model, the response message corresponding to the query request based on the query request.

In some embodiments, if the target communication link is the first communication link, the response message determining module 620 is further configured to: determine, by using the trained language model, a response corresponding to the query request based on the query request; and generate at least one response message based on the response according to the predetermined data structure corresponding to the UDP protocol, each of the at least one response message including at least a portion of the response and further including at least one of: an identifier of a session for receiving the query request, a content type of the response, a content type including at least a speech type and a text type, a ranking of the response message in the at least one response message, whether the response message is a last response message in the at least one response message, and a length of at least a portion of the response included in the response message.

The units and/or modules included in the apparatus 500/apparatus 600 may be implemented in various ways, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 500/apparatus 600 may be implemented, at least in part, by one or more hardware logic components. By way of example and not limitation, an available example type of a hardware logic component includes a field programmable gate array (FPGA), an application specific integrated circuit (ASIC), an application specific standard product (ASSP), a system-on-chip (SOC), a complex programmable logic device (CPLD), and the like.

It should be understood that one or more steps of the above method may be performed by a suitable electronic device or a combination of electronic devices. Such an electronic device or such a combination of electronic devices may include, for example, the client device 110 and/or the server device 120 in FIG. 1.

FIG. 7 illustrates a block diagram of an electronic device 700 in which one or more embodiments of the disclosure may be implemented. It should be understood that the electronic device 700 illustrated in FIG. 7 is merely illustrative and should not constitute any limitation on the functionality and scope of the embodiments described herein. The electronic device 700 shown in FIG. 7 may be configured to implement the client device 110 and/or the server device 120 in FIG. 1.

As shown in FIG. 7, the electronic device 700 is in a form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In a multiprocessor system, a plurality of processing units execute computer-executable instructions in parallel to improve a parallel processing capability of the electronic device 700.

The electronic device 700 typically includes a plurality of computer storage media. Such media may be any available media accessible to the electronic device 700, including, but not limited to, volatile and non-volatile media, and removable and non-removable media. The memory 720 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 730 may be a removable or non-removable medium and may include a machine-readable medium, such as a flash drive, a magnetic disk, or any other medium, which may be capable of storing information and/or data and may be accessed within the electronic device 700.

The electronic device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the disclosure.

The communication unit 740 is configured to communicate with other electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed. The external device, such as a storage device, a display device, etc., communicates with one or more devices that enable a user to interact with the electronic device 700, or communicates with any device (e.g., a network card, a modem, etc.) that enables the electronic device 700 to communicate with one or more other electronic devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided. The computer program product is tangibly stored in a non-transitory computer-readable medium and includes computer-executable instructions, and the computer-executable instructions are executed by a processor to implement the method described above.

Aspects of the disclosure are described herein with reference to flowcharts and/or block diagrams of methods, apparatuses, devices, and computer program products implemented in accordance with the disclosure. It should be understood that each block of the flowchart and/or block diagram, and a combination of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by the processing unit of the computer or other programmable data processing apparatus, produce an apparatus to implement the functions/acts specified in the flowchart and/or block diagram. These computer-readable program instructions may also be stored in a computer-readable storage medium, and cause the computer, programmable data processing apparatus, and/or other devices to work in a particular manner, such that the computer-readable medium storing instructions includes an article of manufacture including instructions to implement aspects of the functions/acts specified in the one or more blocks in the flowchart(s) and/or block diagram(s).

The computer-readable program instructions may be loaded onto a computer, other programmable data processing apparatus, or other apparatus, such that a series of operational steps are performed on the computer, other programmable data processing apparatus, or other apparatus to produce a computer-implemented process, such that the instructions executed on the computer, other programmable data processing apparatus, or other apparatus implement the functions/acts specified in one or more blocks in the flowchart(s) and/or block diagram(s).

The flowchart(s) and block diagram(s) in the figures show architecture, functionality, and operation of systems, methods, and computer program products, which may be possibly implemented, according to various implementations of the disclosure. In this regard, each block in the flowchart or block diagram may represent a module, a program segment, or a portion of an instruction that includes one or more executable instructions for implementing the specified logical function. In some implementations as an update, the functions noted in the block(s) may also occur in a different order than that shown in the figures. For example, two consecutive blocks may actually be performed substantially in parallel, which may sometimes be performed in the reverse order, depending on the functionality involved. It is also noted that each block in the block diagram and/or flowchart, as well as a combination of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. M any modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for response processing, implemented at a client device, the method comprising:
sending, in response to receiving a query request for a digital assistant in a session with the digital assistant, the query request to a server device via a first communication link;
receiving a response message for the query request from the server device via a target communication link of a plurality of communication links, the plurality of communication links comprising at least the first communication link; and
providing the response message as a reply of the digital assistant to the query request.

2. The method of claim 1, wherein the target communication link is determined from the plurality of communication links based on at least one of:
a networking capability of the client device,
a link indication sent by the client device to the server device, or
a message notification from the server device.

3. The method of claim 2, further comprising:
providing the link indication to the server device in response to receiving a selection of the target communication link from the plurality of communication links, the link indication comprising an indication for the selected target communication link; or
sending, to the server device, the link indication indicating the first communication link in response to determining that the networking capability of the client device is higher than a first capability level; or
providing the link indication indicating a second communication link to the server device in response to determining that the networking capability of the client device is lower than a second capability level, a communication reliability of the second communication link being higher than a communication reliability of the first communication link.

4. The method of claim 3, wherein the link indication is provided to the server device via a message queuing telemetry transport (MQTT) link.

5. The method of claim 3, wherein the target communication link comprises a communication link indicated by the link indication.

6. The method of claim 1, wherein the target communication link comprises a communication link corresponding to a hypertext transfer (HTTP) protocol, which is different from the first communication link, and wherein receiving the response message from the server device via the target communication link comprises:
receiving, via an MQTT link, a first message notification provided by the server device, the first message notification comprising an access link for the response message, and the response message being of a non-instruction type; and
receiving, in response to receiving the first message notification, the response message from the server device based on the access link via the communication link corresponding to the HTTP protocol.

7. The method of claim 1, wherein the target communication link comprises an MQTT link which is different from the first communication link, and wherein receiving the response message from the server device via the target communication link comprises:
receiving, via the MQTT link, a second message notification provided by the server device, the second message notification comprising the response message of an instruction type.

8. The method of claim 1, wherein the first communication link comprises a communication link based on a user datagram (UDP) protocol, and wherein sending the query request to the server device via the predetermined first communication link comprises:
generating at least one request message based on the query request according to a predetermined data structure corresponding to the UDP protocol, each of the at least one request message comprising at least a portion of the query request and further comprising at least one of:
an identifier of the session,
a content type of the query request, the content type comprising at least a speech type and a text type, or
a ranking of the request message in the at least one request message, and
whether the request message is a last request message in the at least one request message; and
sending the at least one request message to the server device via the first communication link.

9. A method for response processing, implemented at a server device, the method comprising:
receiving a query request for a digital assistant from a client device via a predetermined first communication link;
determining a response message corresponding to the query request; and
sending the response message to the client device via a target communication link of a plurality of communication links, the plurality of communication links comprising at least the first communication link.

10. The method of claim 9, further comprising determining the target communication link from the plurality of communication links based on at least one of:
a networking capability of the client device,
a link indication sent by the client device to the server device, or
a message type of the response message.

11. The method of claim 10, wherein determining the target communication link for message transmission from the plurality of communication links based on the networking capability of the client device comprises:
determining the networking capability of the client device;
determining a second communication link as the target communication link in response to the networking capability of the client device being lower than a third capability level, a communication reliability of the second communication link being higher than a communication reliability of the first communication link; and
determining the first communication link as the target communication link in response to the networking capability of the client device being higher than a fourth capability level.

12. The method of claim 11, wherein receiving the query request comprises receiving a plurality of request messages corresponding to the query request, each of the plurality of request messages comprising at least a portion of the query request; and
determining the networking capability of the client device comprises:
determining, in response to receiving the plurality of request messages corresponding to the query request, the networking capability of the client device based on a ranking indicated by the plurality of request messages and a receiving sequence of the plurality of request messages.

13. The method of claim 10, wherein determining the target communication link for message transmission from the plurality of communication links based on the link indication sent by the client device to the server device comprises:
determining, in response to receiving the link indication, a communication link indicated by the link indication as the target communication link.

14. The method of claim 10, wherein the plurality of communication links further comprises a message queuing telemetry transport (MQTT) link, and wherein determining the target communication link for message transmission from the plurality of communication links based on the message type of the response message comprises:
determining the MQTT link as the target communication link in response to the message type of the response message being an instruction type.

15. The method of claim 9, wherein the target communication link comprises an MQTT link which is different from the first communication link, and the method further comprises:
providing a first message notification to the client device via the MQTT link in response to determining that the response message is of a non-instruction type and determining that the response message is sent via a communication link corresponding to a HTTP protocol, the first message notification comprising an access link of the response message; and
sending the response message to the client device based on the access link via the communication link corresponding to the HTTP protocol.

16. An electronic device, comprising:
at least one processor; and
at least one memory coupled to the at least one processor and storing instructions for being executed by the at least one processor, the instructions, when executed by the at least one processor, causing the electronic device to perform operations comprising:
sending, in response to receiving a query request for a digital assistant in a session with the digital assistant, the query request to a server device via a predetermined first communication link;
receiving a response message for the query request from the server device via a target communication link of a plurality of communication links, the plurality of communication links comprising at least the first communication link; and
providing the response message as a reply of the digital assistant to the query request.

17. The electronic device of claim 16, wherein the target communication link is determined from the plurality of communication links based on at least one of:
a networking capability of the electronic device,
a link indication sent by the electronic device to the server device, or
a message notification from the server device.

18. The electronic device of claim 17, wherein the operations further comprise:
providing the link indication to the server device in response to receiving a selection of the target communication link from the plurality of communication links, the link indication comprising an indication for the selected target communication link; or
sending, to the server device, the link indication indicating the first communication link in response to determining that the networking capability of the electronic device is higher than a first capability level; or
providing the link indication indicating a second communication link to the server device in response to determining that the networking capability of the electronic device is lower than a second capability level, a communication reliability of the second communication link being higher than a communication reliability of the first communication link.

19. The electronic device of claim 16, wherein the target communication link comprises a communication link corresponding to a hypertext transfer (HTTP) protocol, which is different from the first communication link, and wherein receiving the response message from the server device via the target communication link comprises:
receiving, via an MQTT link, a first message notification provided by the server device, the first message notification comprising an access link for the response message, and the response message being of a non-instruction type; and
receiving, in response to receiving the first message notification, the response message from the server device based on the access link via the communication link corresponding to the HTTP protocol.

20. The electronic device of claim 16, wherein the target communication link comprises an MQTT link which is different from the first communication link, and wherein receiving the response message from the server device via the target communication link comprises:
receiving, via the MQTT link, a second message notification provided by the server device, the second message notification comprising the response message of an instruction type.
